(19) United States
(12) Patent Application Publication
(10) Pub. No.: US 2024/0402720 A1
(43) Pub. Date: Dec. 5, 2024

(54) VEHICLE CONTROL METHOD AND APPARATUS, STORAGE MEDIUM, ELECTRONIC DEVICE, AND PROGRAM PRODUCT

(71) Applicant: Tencent Technology ( Shenzhen) Company Limited, Shenzhen (CN)

(72) Inventor: Yixue LEI, Shenzhen (CN)

(73) Assignee: Tencent Technology ( Shenzhen) Company Limited, Shenzhen (CN)

(21) Appl. No.: 18/494,269

(22) Filed: Oct. 25, 2023

Related U.S. Application Data
(63) Continuation of application No. PCT/CN2022/131911, filed on Nov. 15, 2022.

(30) Foreign Application Priority Data
Jan. 28, 2022 (CN) 202210107656.8

(51) Int. Cl. G05D 1/226

(52) U.S. Cl. CPC G05D 1/226

(57) ABSTRACT

Vehicle control including receiving vehicle information from a vehicle and roadside information from a roadside device, where the vehicle is within a coverage area of the roadside device, and establishing a configuration for remotely driving the vehicle based on the vehicle information and roadside information.

### RELATED APPLICATION

This application is a continuation of PCT/CN2022/131911 filed on Nov. 15, 2022, which claims priority to Chinese Patent Application No. 202210107656.8 filed on Jan. 28, 2022, which is incorporated herein by reference in its entirety.

### FIELD

The disclosure relates to the field of computer and communication technologies, and in particular, to a vehicle control method and apparatus, a computer-readable storage medium, an electronic device, and a program product.

### BACKGROUND

Remote driving is a technology that uses mobile communication to control a vehicle over a long distance, and is an important means to resolve problems related to operations performed in dangerous and harsh environments (such as earthquake relief, toxic environments, dangerous tunnels, fire-fighting and rescue, cliff clearing, and explosion site cleanup). The development of the fifth generation mobile communication technology (5G) network provides strong support for such a low-latency driving method.

In the related art, the basic principle of remote driving is to transmit a driving instruction to the vehicle in a downward direction through the network. To transfer a driving instruction, status parameters of the vehicle and visual information need to be first transmitted to a remote control end in an upward direction through the network. In addition, remote driving also includes a plurality of driving modes, such as a human remote driving (Human Remote Control, HRC) mode and a machine driving (Machine Remote Control, MRC) mode. However, in the remote driving mode in the related art, a relatively large amount of data needs to be transmitted in the upward direction, occupying more upstream bandwidth, which results in inefficient use of wireless transmission resources.

### SUMMARY

Embodiments of the disclosure provide a vehicle control method and apparatus, a computer-readable storage medium, an electronic device, and a computer program product, which can reduce an amount of uplink transmitted data of a vehicle and reduce the occupation of an upstream bandwidth, thereby facilitating efficient use of wireless transmission resources.

Some embodiments of the disclosure provide a vehicle control method, including: establishing a communication connection to a roadside device, and obtaining a sensing coverage area of the roadside device and sensing capability information of the roadside device; receiving vehicle status information transmitted by a vehicle and location information of the vehicle; in a case that it is determined according to the location information that the vehicle is located within the sensing coverage area of the roadside device, generating, according to the sensing capability information of the roadside device, uplink configuration information for remotely controlling the vehicle, the uplink configuration information being used for indicating data that needs to be transmitted by the vehicle; and transmitting the uplink configuration information to the vehicle.

Some embodiments of the disclosure provide a vehicle control method, including: performing a communication connection with a remote control end and a vehicle; receiving vehicle status information transmitted by the vehicle, and sensing road environment information of the vehicle; transmitting the vehicle status information and the road environment information to the remote control end; receiving a remote control instruction transmitted by the remote control end, the remote control instruction being generated based on the vehicle status information and the road environment information; and transmitting a control instruction to the vehicle based on the remote control instruction.

Some embodiments of the disclosure provide a vehicle control method, including: establishing a communication connection to a roadside device; receiving vehicle status information of a vehicle and road environment information of the vehicle that are transmitted by the roadside device, the vehicle status information of the vehicle being transmitted by the vehicle to the roadside device; generating a remote control instruction according to the vehicle status information and the road environment information; and transmitting the remote control instruction to the roadside device, the remote control instruction being used for transmitting a control instruction to the vehicle by the roadside device based on the remote control instruction.

Some embodiments of the disclosure provide a vehicle control method, including: receiving vehicle status information transmitted by a vehicle and road environment information transmitted through structured data by the vehicle in a human remote driving mode; performing scene rendering according to the structured data to obtain a road environment of the vehicle; presenting the road environment of the vehicle; receiving a remote control instruction, the remote control instruction being triggered by a remote driver based on the road environment and the vehicle status information; and transmitting the remote control instruction to the vehicle.

Some embodiments of the disclosure provide a vehicle control apparatus, including: an obtaining unit, configured to establish a communication connection to a roadside device, and obtain a sensing coverage area of the roadside device and sensing capability information of the roadside device; a receiving unit, configured to receive vehicle status information transmitted by a vehicle and location information of the vehicle; a generation unit, configured to: in a case that it is determined according to the location information that the vehicle is located within the sensing coverage area of the roadside device, generate, according to the sensing capability information of the roadside device, uplink configuration information for remotely controlling the vehicle, the uplink configuration information being used for indicating data that needs to be transmitted by the vehicle; and a sending unit, configured to transmit the uplink configuration information to the vehicle.

Some embodiments of the disclosure provide a vehicle control apparatus, including: a connection unit, configured to perform a communication connection with a remote control end and a vehicle; an obtaining unit, configured to receive vehicle status information transmitted by the vehicle, and sense road environment information of the vehicle; a sending unit, configured to transmit the vehicle status information and the road environment information to the remote control end; and an interaction unit, configured to receive a remote control instruction transmitted by the remote control end, the remote control instruction being generated based on the vehicle status information and the road environment information; and transmit a control instruction to the vehicle based on the remote control instruction.

Some embodiments of the disclosure provide a vehicle control apparatus, including: a connection unit, configured to establish a communication connection to a roadside device; a receiving unit, configured to receive vehicle status information of a vehicle and road environment information of the vehicle that are transmitted by the roadside device, the vehicle status information of the vehicle being transmitted by the vehicle to the roadside device; a generation unit, configured to generate a remote control instruction according to the vehicle status information and the road environment information; and a sending unit, configured to transmit the remote control instruction to the roadside device, the remote control instruction being used for transmitting a control instruction to the vehicle by the roadside device based on the remote control instruction.

Some embodiments of the disclosure provide a vehicle control apparatus, including: a receiving unit, configured to receive vehicle status information transmitted by a vehicle and road environment information transmitted through structured data by the vehicle in a human remote driving mode; a generation unit, configured to perform scene rendering according to the structured data to obtain a road environment of the vehicle; a presentation unit, configured to present the road environment of the vehicle; and an interaction unit, configured to receive a remote control instruction, the remote control instruction being triggered by a remote driver based on the road environment and the vehicle status information, and transmit the remote control instruction to the vehicle.

Some embodiments of the disclosure provide a computer-readable storage medium, storing a computer program, the computer program, when executed by a processor, implementing the vehicle control method according to the foregoing embodiment.

Some embodiments of the disclosure provide an electronic device, including: one or more processors; and a storage apparatus, configured to store one or more programs, the one or more programs, when executed by the one or more processors, causing the electronic device to implement the vehicle control method according to the foregoing embodiment.

Some embodiments of the disclosure provide a computer program product or a computer program, including a computer instruction, the computer instruction being stored in a computer-readable storage medium. A processor of a computer device reads the computer instruction from the computer-readable storage medium and executes the computer instruction, to cause the computer device to perform the vehicle control method provided in the foregoing optional embodiments.

In the technical solutions provided in some embodiments of the disclosure, a communication connection may be established (by a remote control end) to a roadside device, and a sensing coverage area of the roadside device and sensing capability information of the roadside device may be obtained. Further, in a case that it is determined, according to location information of a vehicle, that the vehicle is located within the sensing coverage area of the roadside device, uplink configuration information for remote control may be generated according to the sensing capability information of the roadside device to indicate, through the uplink configuration information, data that needs to be transmitted by the vehicle, so that the remote control end can dynamically adjust, according to the sensing capability information of the roadside device, data that needs to be transmitted by the vehicle during remote driving. In this way, an amount of data transmitted by the vehicle can be reduced by using the sensing capability information of the roadside device, and the occupation of an upstream bandwidth is reduced, thereby facilitating efficient use of wireless transmission resources.

In the technical solutions provided in some embodiments of the disclosure, a communication connection is performed (by a roadside device) with a remote control end and a vehicle, to transmit vehicle status information transmitted by the vehicle and sensed road environment information of the vehicle to the remote control end. Then, a remote control instruction transmitted by the remote control end based on the vehicle status information and the road environment information are received to transmit a control instruction to the vehicle based on the remote control instruction, so that the vehicle does not need to transmit the road environment information to the remote control end. In this way, an amount of data transmitted by the vehicle can be reduced, and the occupation of an upstream bandwidth is reduced, thereby facilitating efficient use of wireless transmission resources.

The technical solutions provided in the embodiments of the disclosure can have the following beneficial effects:

Vehicle status information transmitted by a vehicle and road environment information of the vehicle in a human remote driving mode are received (by a remote control end), and scene rendering processing is performed according to the road environment information to generate a road environment of the vehicle. Then, the road environment of the vehicle is presented, and a remote control instruction triggered by a remote driver based on the road environment and the vehicle status information is received. The remote control instruction is transmitted to the vehicle, so that in the human remote driving mode, the vehicle does not need to transmit audio and video data of the road environment to the remote control end, but can reduce an amount of data transmitted by the vehicle through transmission of the road environment information, thereby reducing the occupation of an upstream bandwidth.

In a case that the vehicle is located within a sensing coverage area of a roadside device, uplink configuration information for remotely controlling the vehicle is generated according to sensing capability information of the roadside device to indicate data that needs to be transmitted by the vehicle. In this way, data that needs to be transmitted by the vehicle during remote driving can be dynamically adjusted according to the sensing capability information of the roadside device, to control, by using the sensing capability information of the roadside device, an amount of data transmitted by the vehicle, thereby facilitating efficient use of wireless transmission resources.

In some embodiments of the disclosure, a vehicle control method may be provided, where the method may include: receiving one or more vehicle information from a vehicle; receiving one or more roadside information from a roadside device, wherein the vehicle may be within a coverage area of the roadside device; and establishing a configuration for performing a remote driving for the vehicle based on the one or more vehicle information and the one or more roadside information.

In some embodiments of the disclosure the method may further comprise establishing a communication connection to the roadside device through a wired connection.

In some embodiments of the disclosure, the one or more roadside information may include a sensing coverage area of the roadside device and sensing capability information of the roadside device; the one or more vehicle information may include vehicle status information and location information of the vehicle; and the establishing the configuration for performing the remote driving may include: in a case that it is determined according to the location information that the vehicle is located within the sensing coverage area of the roadside device, generating, according to the sensing capability information of the roadside device, uplink configuration information for remotely controlling the vehicle, the uplink configuration information may be used for indicating data that needs to be transmitted by the vehicle; and transmitting the uplink configuration information to the vehicle.

In some embodiments of the disclosure, the generating, according to the sensing capability information of the roadside device, uplink configuration information for remotely controlling the vehicle may include in a case that it is determined according to the sensing capability information of the roadside device that the roadside device is capable of providing road environment information of the vehicle, generating uplink configuration information for indicating reduction of data transmission of the vehicle.

In some embodiments of the disclosure, after the transmitting the uplink configuration information to the vehicle, the method may further include: obtaining road environment information of the vehicle sensed by the roadside device, and receiving vehicle status data transmitted by the vehicle; generating a remote control instruction based on the vehicle status data and the road environment information; and transmitting the remote control instruction to the vehicle, the remote control instruction may be used for remotely controlling the vehicle to travel.

In some embodiments of the disclosure, the method may further include establishing a communication connection to the roadside device through a wired connection, wherein the one or more vehicle information may be received from the vehicle via the roadside device, and wherein the configuration for performing the remote driving may be established via the roadside device.

In some embodiments of the disclosure, the one or more vehicle information may include vehicle status information of the vehicle, the one or more roadside information may include road environment information of the vehicle, and the vehicle status information of the vehicle may be transmitted by the vehicle to the roadside device; and the establishing the configuration for performing the remote driving may include: generating a remote control instruction according to the vehicle status information and the road environment information; and transmitting the remote control instruction to the roadside device, the remote control instruction may be used for transmitting a control instruction to the vehicle by the roadside device based on the remote control instruction.

In some embodiments of the disclosure, the one or more roadside information may further include sensing coverage area and communication capability information of the roadside device; and the method may further include, in a case that it is determined according to the sensing coverage area and the communication capability information of the roadside device that the roadside device is capable of assisting in remote driving, switching communication with the vehicle to communication between the vehicle and the roadside device.

In some embodiments of the disclosure, the one or more vehicle information may include vehicle status information of the vehicle, the one or more roadside information may include road environment information of the vehicle, the vehicle status information and the road environment information may be received in a human remote driving mode; and the establishing the configuration for performing the remote driving may include: performing scene rendering according to the road environment information to obtain a road environment of the vehicle; presenting the road environment of the vehicle; receiving a remote control instruction, the remote control instruction may be triggered by a remote driver based on the road environment and the vehicle status information; and transmitting the remote control instruction to the vehicle.

In some embodiments of the disclosure, the road environment information of the vehicle is received through structured data.

According to some embodiments of the disclosure, a vehicle control apparatus is provided. The apparatus may include: at least one non-transitory memory containing program code; and at least one processor configured to execute the program code, the program code may include: first receiving code configured to cause the at least one processor to receive one or more vehicle information from a vehicle; second receiving code configured to cause the at least one processor to receive one or more roadside information from a roadside device, wherein the vehicle may be within a coverage area of the roadside device; and first establishing code configured to cause the at least one processor to establish a configuration for performing a remote driving for the vehicle based on the one or more vehicle information and the one or more roadside information.

According to some embodiments of the disclosure, a non-transitory computer-readable medium for vehicle control is provided. The non-transitory computer-readable medium may contain program code that when executed by at least one processor, causes the at least one processor to: receive one or more vehicle information from a vehicle; receive one or more roadside information from a roadside device, wherein the vehicle may be within a coverage area of the roadside device; and establish a configuration for performing a remote driving for the vehicle based on the one or more vehicle information and the one or more roadside information.

### BRIEF DESCRIPTION OF THE DRAWINGS

FIG. 1 is a schematic diagram of a remote driving scene.

FIG. 2 is a schematic diagram of an exemplary system architecture according to some embodiments of the disclosure.

FIG. 3 is a schematic diagram of an exemplary system architecture according to some embodiments of the disclosure.

FIG. 4 is a schematic diagram of an exemplary system architecture according to some embodiments of the disclosure.

FIG. 5 is a flowchart of a vehicle control method according to some embodiments of the disclosure.

FIG. 6 is a flowchart of a vehicle control method according to some embodiments of the disclosure.

FIG. 7 is a flowchart of a vehicle control method according to some embodiments of the disclosure.

FIG. 8 is a flowchart of a vehicle control method according to some embodiments of the disclosure.

FIG. 9 is a flowchart of a vehicle control method according to some embodiments of the disclosure.

FIG. 10 is a flowchart of a vehicle control method according to some embodiments of the disclosure.

FIG. 11 is a flowchart of a vehicle control method according to some embodiments of the disclosure.

FIG. 12 is a block diagram of a vehicle control apparatus according to some embodiments of the disclosure.

FIG. 13 is a block diagram of a vehicle control apparatus according to some embodiments of the disclosure.

FIG. 14 is a block diagram of a vehicle control apparatus according to some embodiments of the disclosure.

FIG. 15 is a block diagram of a vehicle control apparatus according to some embodiments of the disclosure.

FIG. 16 is a schematic structural diagram of an electronic device according to some embodiments of the disclosure.

### DETAILED DESCRIPTION

To make the objectives, technical solutions, and advantages of the disclosure clearer, the following describes implementations of the disclosure in detail with reference to the accompanying drawings.

In addition, the features, structures, or characteristics described in the disclosure may be combined in one or more embodiments in any appropriate manner. In the following descriptions, a lot of details are provided to give a comprehensive understanding of the embodiments of the disclosure. However, a person of ordinary skill in the art is to be aware that, the technical solutions in the disclosure may be implemented without all detailed features in the embodiments, or with one or more particular details omitted, or with other methods, components, apparatuses, operations, or the like used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

“A plurality of” mentioned in this specification means two or more. The term “and/or” describes an association relationship between associated objects, indicating that there may be three relationships. For example, A and/or B may represent the following three cases: Only A exists, both A and B exist, and only B exists. The character “/” generally indicates an “or” relationship between the associated objects.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operation/interaction system, and electromechanical integration. AI software technologies mainly include several major directions such as a computer vision (CV) technology, a speech processing technology, a natural language processing technology, machine learning/deep learning, automated driving, and intelligent transportation.

The automated driving technology may rely on AI, visual computing, radar, and a monitoring apparatus to cooperate with a global positioning system to allow a computer to autonomously and safely perform an operation on a motor vehicle without any human active operation. The automated driving technology usually includes high-definition maps, environment sensing, behavioral decision-making, route planning, motion control, and other technologies. The automated driving technology has a wide range of application prospects.

Remote driving is a technology between automated driving and human driving. Remote driving is a technology that uses mobile communication to control a vehicle over a long distance, and mainly includes HRC and MRC. As the name suggests, HRC means remote driving by humans, and MRC means remote driving by machines. MRC is a type of automated driving.

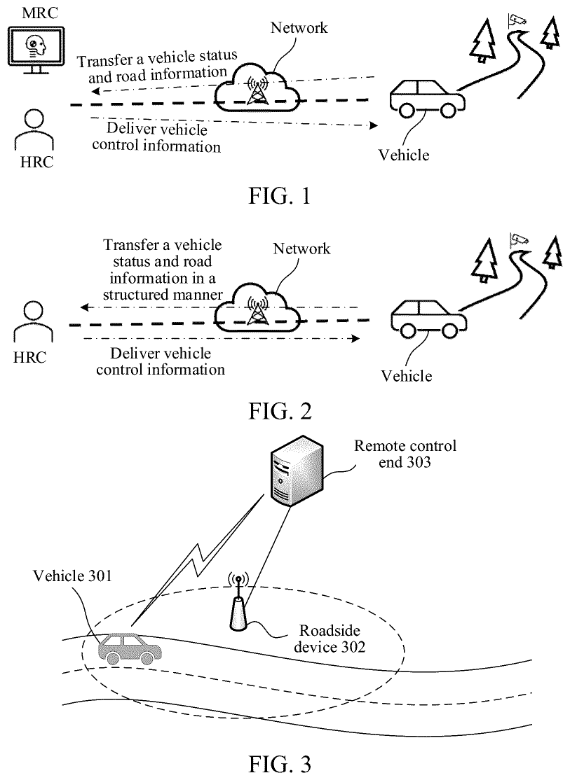

The basic principle of remote driving is that a vehicle transmits status parameters and visual information of the vehicle to a remote control end in an upward direction, and then the remote control end transmits a driving instruction to the vehicle in a downward direction through a network. As shown in FIG. 1, in a remote driving scene of the disclosure, there may be two remote driving modes: MRC and HRC. In the HRC mode, a driver may need to obtain video information related to a visual field of a remote vehicle through a network. Therefore, a relatively large network bandwidth may be required. In the MRC driving mode, vehicle-side information may be transmitted by using structured data or raw format data. Therefore, a relatively small network bandwidth may be occupied. In terms of a downlink control instruction, network transmission requirements of the HRC mode and the MRC mode may be similar. For a 5G system, uplink transmission may be more challenging than downlink transmission, and especially for 5G remote driving, a network data transmission requirement may be higher as driving safety is involved. In the related art, remote driving is affected by many factors such as remote driving modes, vehicle status parameters, audio and video information transmission requirements, 5G network available bandwidth, and road environments, which brings great challenges to the development of 5G remote driving services. As a result, a relatively large upstream bandwidth is occupied, which results in inefficient use of wireless transmission resources.

Based on this, embodiments of the disclosure provide various processing methods to reduce an amount of uplink transmitted data of a vehicle, to reduce the occupation of an upstream bandwidth, thereby facilitating efficient use of wireless transmission resources. In some embodiments, as shown in FIG. 2, in an HRC mode, a vehicle may transmit vehicle status information to a remote control end through a network, and transmit road environment information in a manner of structured data. At the remote control end, an actual road environment can be recovered through rendering according to the structured data and provided to an HRC controller. The HRC controller performs a human driving operation to deliver vehicle control information to the vehicle. In other words, in the embodiment shown in FIG. 2, in the HRC mode, the vehicle transmits the road environment information to the remote control end in the manner of structured data, so that an amount of data transmitted by the vehicle can be reduced and the occupation of an upstream bandwidth is reduced, thereby facilitating efficient use of wireless transmission resources.

In some embodiments of the disclosure, as shown in FIG. 3, a vehicle 301 may establish a communication connection to a remote control end 303, and a roadside device 302 may establish a communication connection to the remote control end 303. For example, the vehicle 301 may communicate with the remote control end 303 through a mobile communication network (that is, in a wireless connection manner). The roadside device 302 may communicate with the remote control end 303 in a wired connection manner (such as through an optical fiber). The roadside device 302 may report a sensing coverage area and sensing capability information thereof to the remote control end 303. The vehicle 301 may report location information thereof to the remote control end 303. Then, in a case that the remote control end 303 determines according to the location information of the vehicle 301 that the vehicle 301 is located within the sensing coverage area of the roadside device 302, uplink configuration information for remote control may be generated according to the sensing capability information of the roadside device 302 to indicate, through the uplink configuration information, data that needs to be transmitted by the vehicle 301. In this way, data that needs to be transmitted by the vehicle during remote driving can be dynamically adjusted according to the sensing capability information of the roadside device, to reduce, by using the sensing capability information of the roadside device, an amount of data transmitted by the vehicle, so that the occupation of an upstream bandwidth is reduced, thereby facilitating efficient use of wireless transmission resources.

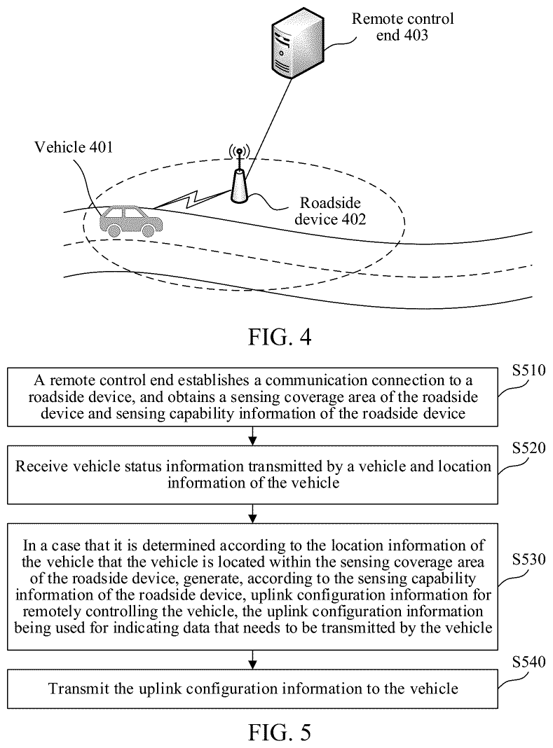

In some embodiments of the disclosure, as shown in FIG. 4, a vehicle 401 may establish a communication connection to a roadside device 402, and the roadside device 402 may establish a communication connection to a remote control end 403. For example, the vehicle 401 may communicate with the roadside device 402 through a mobile communication network (that is, in a wireless connection manner). The roadside device 402 may communicate with the remote control end 403 in a wired connection manner (such as through an optical fiber). The vehicle 401 may transmit vehicle status information thereof to the roadside device 402. The roadside device 402 may transmit the vehicle status information and sensed road environment information of the vehicle 401 to the remote control end 403. Subsequently, the roadside device 402 may receive a remote control instruction transmitted by the remote control end 403 based on the vehicle status information and the road environment information, to transmit a control instruction to the vehicle 401 based on the remote control instruction, so that the vehicle 401 does not need to transmit the road environment information to the remote control end 403. In this way, an amount of data transmitted by the vehicle 401 can be reduced, and the occupation of an upstream bandwidth is reduced, thereby facilitating efficient use of wireless transmission resources.

The implementation details of the technical solutions of the embodiments of the disclosure are described in detail below.

FIG. 5 is a flowchart of a vehicle control method according to some embodiments of the disclosure. The vehicle control method may be performed by a remote control end. The remote control end may be the remote control end 303 shown in FIG. 3. Referring to FIG. 5, the vehicle control method may include operations S510 to S540, which are described in detail as follows:
S510: A remote control end establishes a communication connection to a roadside device, and obtains a sensing coverage area of the roadside device and sensing capability information of the roadside device.

In some embodiments, a communication connection may be established between the remote control end and the roadside device through a wired connection. In this way, the occupation (usage) of wireless resources can be reduced. For example, a communication connection may be established through an optical fiber. The roadside device may transmit the sensing coverage area and the sensing capability information of the roadside device to the remote control end.

In some embodiments, the sensing coverage area of the roadside device may be a range that can be sensed by the roadside device. For example, the range that can be sensed by the roadside device may be a circular area with the roadside device as a center and a target distance (which may vary according to different capabilities of the roadside device) as a radius (that is, a sensing radius). During actual application, the roadside device may sense sense, based on a sensing range thereof, a road environment (such as a traffic flow, a vehicle speed, road pavement, and a road grade) within the sensing range. The sensing capability information of the roadside device may be, for example, sensing accuracy and sensing delay information of the roadside device.
S520: Receive vehicle status information transmitted by a vehicle and location information of the vehicle.

In some embodiments, a communication connection may be performed between the remote control end and the vehicle through a wireless communication network. For example, the communication connection may be performed through a 5G network. The vehicle status information of the vehicle may be a speed, acceleration, a direction angle, and other information of the vehicle. The location information of the vehicle may be positioning information of the vehicle obtained through a positioning system. The positioning system may be, for example, the Global Positioning System (GPS) or the Beidou Navigation Satellite System (BDS).
S530: In a case that it is determined, according to the location information of the vehicle, that the vehicle is located within the sensing coverage area of the roadside device, generate, according to the sensing capability information of the roadside device, uplink configuration information for remotely controlling the vehicle, the uplink configuration information being used for indicating data that needs to be transmitted by the vehicle.

In some embodiments, the remote control end may determine, according to the location information of the vehicle, that the vehicle is located within the sensing coverage area of the roadside device. In some embodiments, the remote control end may determine, according to the location information of the vehicle, whether the vehicle is located within the sensing coverage area of the roadside device in the following manner. The remote control end may determine a distance between the vehicle and the roadside device according to the location information of the vehicle. When the distance between the vehicle and the roadside device is less than or equal to the sensing radius of the roadside device, the remote control end may determine that the vehicle is located within the sensing coverage area of the roadside device. When the distance between the vehicle and the roadside device is greater than the sensing radius of the roadside device, the remote control end may determine that the vehicle is outside the sensing coverage area of the roadside device. In this way, the remote control end may obtain road environment information of the vehicle by using a sensing capability of the roadside device, and then generate uplink configuration information for indicating data that needs to be transmitted by the vehicle, so that the vehicle no longer needs to report the road environment information, thereby helping reduce the occupation of an upstream bandwidth.

In some embodiments, the roadside device may provide real-time road environment information. In this way, in a case that it is determined, according to the sensing capability information of the roadside device, that the roadside device can provide real-time road environment information for the vehicle, the remote control end may generate uplink configuration information for indicating reduction of data transmission of the vehicle, to reduce an amount of data reported by the vehicle. On the other hand, in a case that the roadside device cannot provide real-time road environment information, vehicle reporting may be required to ensure the safety of remote driving.
S540: Transmit the uplink configuration information to the vehicle.

In some embodiments, the remote control end may control uplink data transmission of the vehicle by transmitting uplink configuration information. After the remote control end transmits the uplink configuration information to the vehicle, the vehicle may adjust, according to data that needs to be transmitted which is indicated by the uplink configuration information, an amount of data transmitted to the remote control end. For example, the uplink configuration information may indicate reducing or stopping reporting of the road environment information.

In some embodiments of the disclosure, after transmitting the uplink configuration information to the vehicle, the remote control end may obtain real-time road environment information of an environment of the vehicle that is sensed by the roadside device, and receive vehicle status data (such as a speed, acceleration, and a traveling direction of the vehicle) transmitted by the vehicle. Then, a remote control instruction may be generated based on the vehicle status data and the real-time road environment information, and the remote control instruction may be transmitted to the vehicle, to remotely control the vehicle to travel.

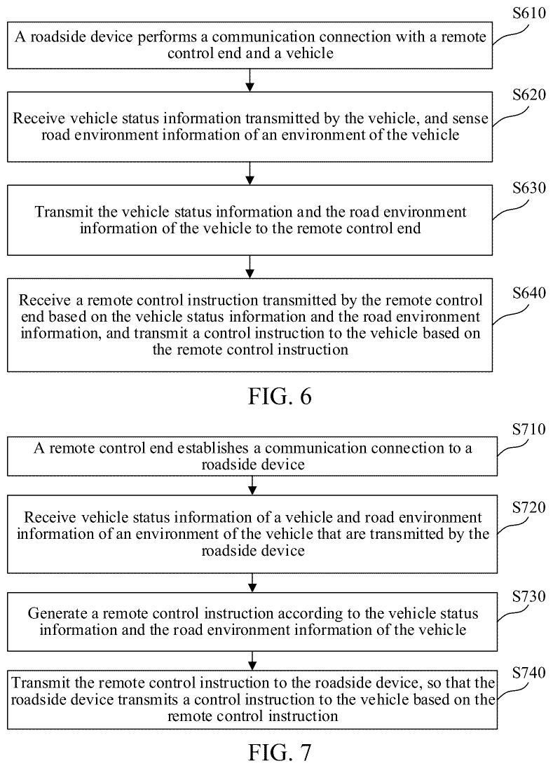

FIG. 6 is a flowchart of a vehicle control method according to some embodiments of the disclosure. The vehicle control method may be performed by a roadside device. The roadside device may be the roadside device 402 shown in FIG. 4. Referring to FIG. 6, the vehicle control method may include operations S610 to S640, which are described in detail as follows:
S610: A roadside device performs a communication connection with a remote control end and a vehicle.

In some embodiments, a communication connection may be established between the roadside device and the remote control end through a wired connection. In this way, the occupation of wireless resources can be reduced. For example, a communication connection may be established through an optical fiber. A communication connection may be performed between the roadside device and the vehicle through a mobile communication network or PC5 communication.
S620: Receive vehicle status information transmitted by the vehicle, and sense road environment information of an environment of the vehicle.

In some embodiments, when the vehicle travels into a sensing coverage area of the roadside device, the vehicle may establish a communication connection with the roadside device, and then the roadside device may receive vehicle status information transmitted by the vehicle. In addition, the roadside device may sense a road environment of the vehicle to obtain road environment information. The vehicle status information of the vehicle may be a speed, acceleration, a direction angle, and other information of the vehicle.
S630: Transmit the vehicle status information and the road environment information of the vehicle to the remote control end.

In some embodiments, the roadside device may transmit the vehicle status information and the road environment information of the vehicle to the remote control end through wired communication.
S640: Receive a remote control instruction transmitted by the remote control end based on the vehicle status information and the road environment information, and transmit a control instruction to the vehicle based on the remote control instruction.

In some embodiments, after the roadside device receives the remote control instruction transmitted by the remote control end, if the remote control instruction can be identified by the vehicle, the remote control instruction may be directly forwarded to the vehicle to remotely control the vehicle. If the remote control instruction cannot be identified by the vehicle, the roadside device may parse the remote control instruction to obtain a control instruction that can be identified by the vehicle, and then transmit the obtained control instruction to the vehicle.

FIG. 7 is a flowchart of a vehicle control method according to some embodiments of the disclosure. The vehicle control method may be performed by a remote control end. The remote control end may be the remote control end 403 shown in FIG. 4. Referring to FIG. 7, the vehicle control method may include operations S710 to S740, which are described in detail as follows:
S710: A remote control end establishes a communication connection to a roadside device.

In some embodiments, a communication connection may be established between the roadside device and the remote control end through a wired connection. In this way, the occupation of wireless resources can be reduced. For example, a communication connection may be established through an optical fiber.
S720: Receive vehicle status information of a vehicle and road environment information of an environment of the vehicle that are transmitted by the roadside device.

Herein, during actual application, the vehicle status information of the vehicle may be transmitted by the vehicle to the roadside device.

In some embodiments, when the vehicle travels into a sensing coverage area of the roadside device, the vehicle may establish a communication connection with the roadside device, and then the roadside device may receive the vehicle status information transmitted by the vehicle. In addition, the roadside device may sense the road environment information of the vehicle. Then, the roadside device may transit the received vehicle status information and the sensed road environment information to the remote control end. The vehicle status information of the vehicle may be a speed, acceleration, a direction angle, and other information of the vehicle.

In some embodiments of the disclosure, the remote control end may obtain a sensing coverage area and communication capability information of the roadside device in advance. If it is determined, according to the sensing coverage area and the communication capability information of the roadside device, that the roadside device can assist the vehicle in remote driving, communication interaction with the vehicle may be switched to communication interaction between the vehicle and the roadside device. That is, the vehicle switches a reporting object of the vehicle status information to the roadside device.
S730: Generate a remote control instruction according to the vehicle status information and the road environment information of the vehicle.
S740: Transmit the remote control instruction to the roadside device, so that the roadside device transmits a control instruction to the vehicle based on the remote control instruction.

In some embodiments, if the remote control instruction generated by the remote control end can be directly identified by the vehicle, the roadside device may directly transmit the remote control instruction to the vehicle after receiving the remote control instruction transmitted by the remote control end, to remotely control the vehicle. If the remote control instruction cannot be identified by the vehicle, the roadside device may parse the remote control instruction after receiving the remote control instruction, to obtain a control instruction that can be identified by the vehicle, and then transmit the obtained control instruction to the vehicle.

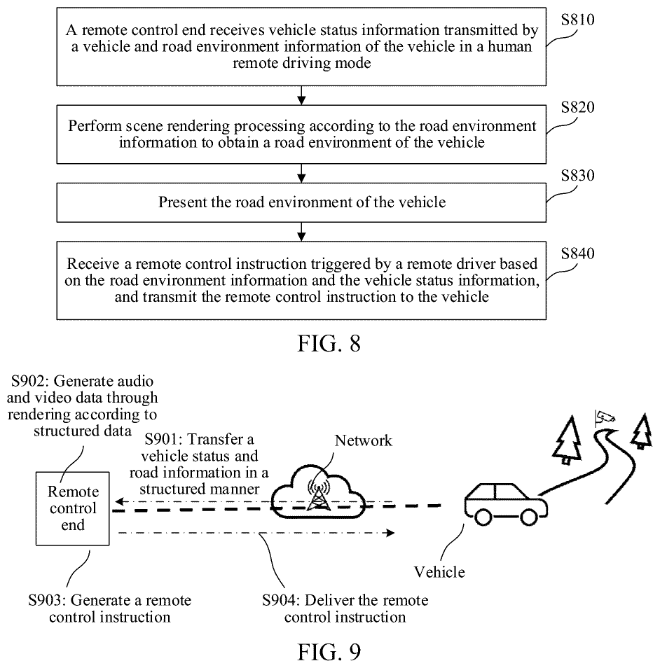

FIG. 8 is a flowchart of a vehicle control method according to some embodiments of the disclosure. The vehicle control method may be performed by a remote control end. The remote control end may be the remote control end of HRC shown in FIG. 2. Referring to FIG. 8, the vehicle control method may include operations S810 to S840, which are described in detail as follows:
S810: A remote control end receives vehicle status information transmitted by a vehicle and road environment information of the vehicle in a human remote driving mode.

In some embodiments, the vehicle may communicate with the remote control end through a wireless communication network. For example, the communication may be performed through a 5G network. In a possible implementation, the vehicle may transmit the road environment information through structured data in the human remote driving mode. The road environment information transmitted by the vehicle through the structured data may be the number of surrounding vehicles in a road environment of the vehicle, the orientation of surrounding vehicles, whether a road condition is a tunnel, or the like. Compared with the method of transmitting audio and video data, the structured data can reduce the amount of data transmitted, thereby reducing the occupation of an upstream bandwidth.
S820: Perform scene rendering processing according to the road environment information to obtain a road environment of the vehicle.

In some embodiments, the remote control end may perform scene rendering processing according to structured data transmitted by the vehicle. For example, the structured data may include information indicating that there are three cars in a left front lane of the vehicle, and the vehicle is in a tunnel. In this case, a tunnel scene can be obtained through rendering, and three cars may be obtained through rendering in the left front lane of the vehicle in the tunnel scene. During actual application, the rendering of the road environment of the vehicle may be real-time rendering, and continuous frame screens of the road environment may be obtained and then output, so that a user can clearly understand the environment of the vehicle.
S830: Present the road environment of the vehicle.

In some embodiments, in an HRC mode, the road environment obtained through rendering may be displayed, so that a remote driver can performs remote driving based on the displayed road environment.
S840: Receive a remote control instruction triggered by a remote driver based on the road environment information and the vehicle status information, and transmit the remote control instruction to the vehicle.

According to the technical solution of the embodiment shown in FIG. 8, in the human remote driving mode, the vehicle may not need to transmit audio and video data of the road environment to the remote control end, and an amount of data transmitted by the vehicle may be reduced by transmitting structured data. In this way, the occupation of an upstream bandwidth is reduced, thereby facilitating efficient use of wireless transmission resources.

The technical solutions of the embodiments of the disclosure are described in detail below with reference to FIG. 9 to FIG. 11.

As shown in FIG. 9, a vehicle control method provided in some embodiments of the disclosure may include the following operations:
S901: Transfer a vehicle status and road information in a structured manner.

During actual application, a vehicle may transmit vehicle status data to a remote control end through a network, and transmit road environment information to the remote control end in a manner of structured data.

Herein, the remote control end may be located in a cloud, and the remote control end may perform remote control in an HRC mode.
S902: Generate audio and video data through rendering according to structured data.

The remote control end may perform rendering according to the structured data to obtain and output at least one of video data and audio data of a road environment of the vehicle.
S903: A remote control end generates a remote control instruction for a vehicle.
S904: The remote control end delivers the remote control instruction for the vehicle to the vehicle to remotely control the vehicle.

According to the technical solution of the embodiment shown in FIG. 9, in the human remote driving mode, the vehicle may not need to transmit audio and video data of the road environment to the remote control end, and an amount of data transmitted by the vehicle may be reduced by transmitting structured data. In this way, the occupation of an upstream bandwidth is reduced, thereby facilitating efficient use of wireless transmission resources.

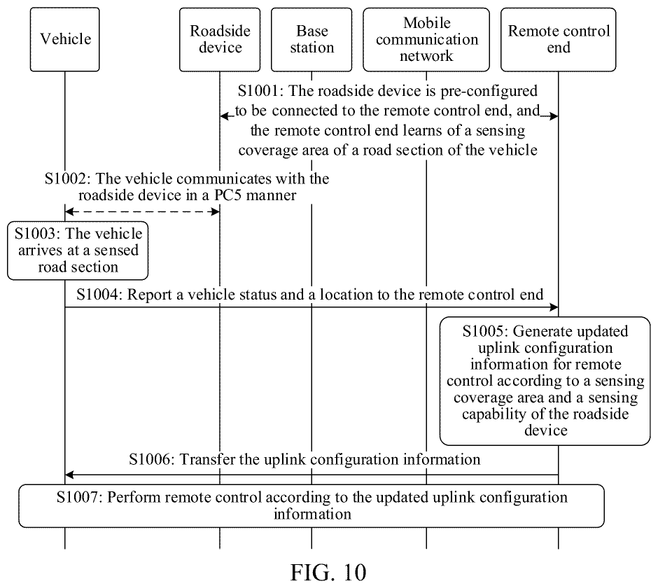

As shown in FIG. 10, a vehicle control method provided in some embodiments of the disclosure may include the following operations:
S1001: A roadside device is pre-configured to be connected to a remote control end, and the remote control end learns of a sensing coverage area of a road section of a vehicle.

In some embodiments, a communication connection may be established between the remote control end and the roadside device through a wired connection. In this way, the occupation of wireless resources can be reduced. For example, a communication connection may be established through an optical fiber.
S1002: The vehicle communicates with the roadside device in a PC5 manner.
S1003: The vehicle arrives at a sensed road section of the roadside device.
S1004: The vehicle reports a vehicle status and a location to the remote control end.

In some embodiments, vehicle status information of the vehicle may be a speed, acceleration, a direction angle, and other information of the vehicle. Location information of the vehicle may be positioning information obtained through a positioning system.
S1005: Generate updated uplink configuration information for remote control according to a coverage area and a sensing capability of the roadside device.

In some embodiments, if it is determined, according to the location information of the vehicle, that the vehicle is located within the sensing coverage area of the roadside device, road environment information of the vehicle may be obtained by using the sensing capability of the roadside device. In this way, the vehicle no longer needs to report the road environment information, thereby helping reduce the occupation of an upstream bandwidth.
S1006: Transfer the uplink configuration information to the vehicle.
S1007: Perform a remote control operation according to the updated uplink configuration information.

In some embodiments, after transmitting the uplink configuration information to the vehicle, the remote control end may obtain real-time road environment information of the vehicle that is sensed by the roadside device, and receive vehicle status data transmitted by the vehicle. Then, a remote control instruction may be generated based on the vehicle status data and the real-time road environment information, and the remote control instruction may be transmitted to the vehicle to control the vehicle to perform remote driving.

According to the technical solution of the embodiment shown in FIG. 10, the remote control end can dynamically adjust, according to sensing capability information of the roadside device, data that needs to be transmitted by the vehicle during remote driving. In this way, an amount of data transmitted by the vehicle can be reduced by using the sensing capability information of the roadside device, and the occupation of an upstream bandwidth is reduced, thereby facilitating efficient use of wireless transmission resources.

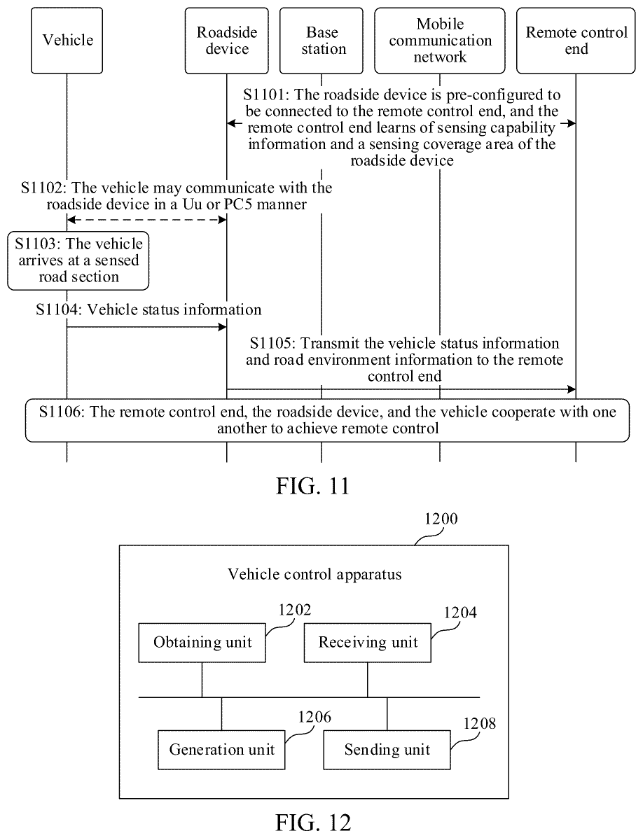

As shown in FIG. 11, a vehicle control method provided in some embodiments of the disclosure may include the following operations:
S1101: A roadside device is pre-configured to be connected to a remote control end, and the remote control end learns of sensing capability information and a sensing coverage area of the roadside device.

In some embodiments, a communication connection may be established between the roadside device and the remote control end through a wired connection. In this way, the occupation of wireless resources can be reduced.
S1102: A vehicle may communicate with the roadside device in a Uu or PC5 manner.

In some embodiments, the communication between the vehicle and the roadside device in the Uu manner may be communication through a mobile communication network (such as a 5G network).
S1103: The vehicle arrives at a sensed road section of the roadside device.
S1104: The vehicle is connected to the roadside device, and transmits vehicle status information to the roadside device.
S1105: The roadside device transmits the vehicle status information and sensed road environment information to the remote control end.

In some embodiments, the roadside device may communicate with the remote control end through an optical fiber and a wired network.
S1106: The remote control end, the roadside device, and the vehicle cooperate with one another to achieve remote control.

According to the technical solution of the embodiment shown in FIG. 11, the vehicle and the remote control end may no longer use an uplink of a public network (such as a 5G network) for remote driving, so that the occupation of an upstream bandwidth is reduced, thereby facilitating efficient use of wireless transmission resources.

The following describes apparatus embodiments of the disclosure, and the apparatus embodiments may be used for performing the vehicle control method in the foregoing embodiments of the disclosure. For details not disclosed in the apparatus embodiments of the disclosure, refer to the foregoing vehicle control method embodiments of the disclosure.

FIG. 12 is a block diagram of a vehicle control apparatus according to some embodiments of the disclosure. The vehicle control apparatus may be disposed in a remote control end. The remote control end may be the remote control end 303 shown in FIG. 3.

Referring to FIG. 12, a vehicle control apparatus 1200 provided in some embodiments of the disclosure may include an obtaining unit 1202, a receiving unit 1204, a generation unit 1206, and a sending unit 1208.

The obtaining unit 1202 may be configured to establish a communication connection to a roadside device, and obtain a sensing coverage area of the roadside device and sensing capability information of the roadside device. The receiving unit 1204 may be configured to receive vehicle status information transmitted by a vehicle and location information of the vehicle. The generation unit 1206 may be configured to: in a case that it is determined, according to the location information, that the vehicle is located within the sensing coverage area of the roadside device, generate, according to the sensing capability information of the roadside device, uplink configuration information for remotely controlling the vehicle, the uplink configuration information being used for indicating data that needs to be transmitted by the vehicle. The sending unit 1208 may be configured to transmit the uplink configuration information to the vehicle.

In some embodiments of the disclosure, based on the foregoing solution, the generation unit 1206 may be configured to: in a case that it is determined, according to the sensing capability information of the roadside device, that the roadside device is capable of providing road environment information of the vehicle, generate uplink configuration information for indicating reduction of data transmission of the vehicle.

In some embodiments of the disclosure, based on the foregoing solution, the obtaining unit 1202 may be further configured to: after transmitting the uplink configuration information to the vehicle, obtain real-time road environment information of the vehicle sensed by the roadside device, and receive vehicle status data transmitted by the vehicle. The generation unit 1206 may be further configured to generate a remote control instruction based on the vehicle status data and the real-time road environment information. The sending unit 1208 may be further configured to transmit the remote control instruction to the vehicle to control the vehicle to perform remote driving.

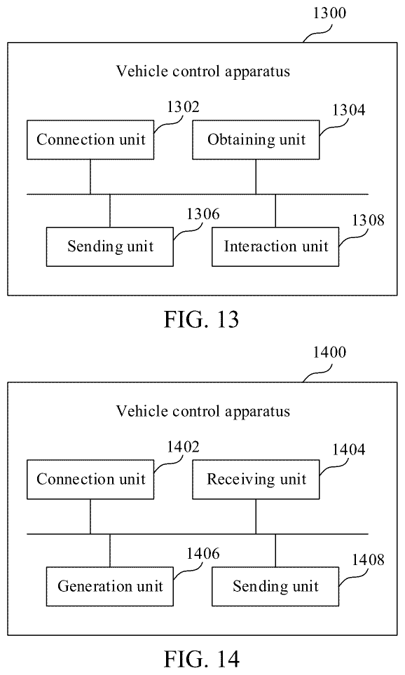

FIG. 13 is a block diagram of a vehicle control apparatus according to some embodiments of the disclosure. The vehicle control apparatus may be disposed in a roadside device. The roadside device may be the roadside device 402 shown in FIG. 4.

Referring to FIG. 13, a vehicle control apparatus 1300 according to some embodiments of the disclosure may include a connection unit 1302, an obtaining unit 1304, a sending unit 1306, and an interaction unit 1308.

The connection unit 1302 may be configured to perform a communication connection with a remote control end and a vehicle. The obtaining unit 1304 may be configured to receive vehicle status information transmitted by the vehicle, and sense a road environment of the vehicle to obtain corresponding road environment information. The sending unit 1306 may be configured to transmit the vehicle status information and the road environment information to the remote control end. The interaction unit 1308 may be configured to receive a remote control instruction transmitted by the remote control end, the remote control instruction being generated based on the vehicle status information and the road environment information, to transmit a control instruction to the vehicle based on the remote control instruction.

In some embodiments of the disclosure, based on the foregoing solution, the interaction unit 1308 may be configured to forward the remote control instruction to the vehicle; or parse the remote control instruction to obtain a control instruction for the vehicle, and transmit the control instruction to the vehicle.

In some embodiments of the disclosure, based on the foregoing solution, a communication connection may be performed with the vehicle through a mobile communication network or PC5 communication.

FIG. 14 is a block diagram of a vehicle control apparatus according to some embodiments of the disclosure. The vehicle control apparatus may be disposed in a remote control end. The remote control end may be the remote control end 403 shown in FIG. 4.

Referring to FIG. 14, a vehicle control apparatus 1400 provided in some embodiments of the disclosure may include a connection unit 1402, a receiving unit 1404, a generation unit 1406, and a sending unit 1408.

The connection unit 1402 may be configured to establish a communication connection to a roadside device. The receiving unit 1404 may be configured to receive vehicle status information of a vehicle and road environment information of the vehicle that are transmitted by the roadside device, the vehicle status information of the vehicle being transmitted by the vehicle to the roadside device. The generation unit 1406 may be configured to generate a remote control instruction according to the vehicle status information and the road environment information. The sending unit 1408 may be configured to transmit the remote control instruction to the roadside device, so that the roadside device may transmit a control instruction to the vehicle based on the remote control instruction.

In some embodiments of the disclosure, based on the foregoing solution, the vehicle control apparatus 1400 may further include a processing unit, configured to: before the vehicle status information of the vehicle and the road environment information of the vehicle that are transmitted by the roadside device is received, obtain a sensing coverage area and communication capability information of the roadside device; and in a case that it is determined, according to the sensing coverage area and the communication capability information of the roadside device, that the roadside device is capable of assisting in remote driving, switch communication interaction with the vehicle to communication interaction between the vehicle and the roadside device.

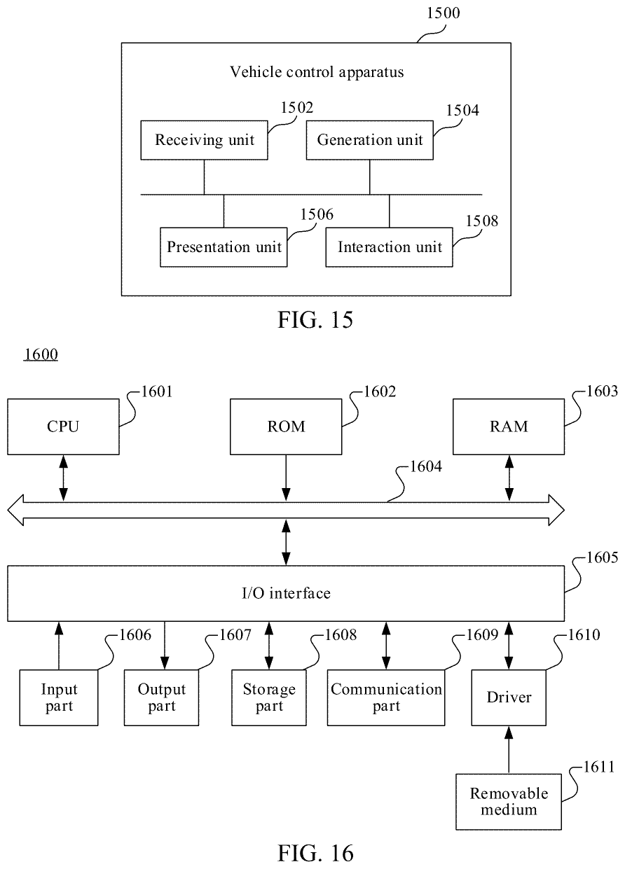

FIG. 15 is a block diagram of a vehicle control apparatus according to some embodiments of the disclosure. The vehicle control apparatus may be disposed in a remote control end. The remote control end may be the remote control end of HRC shown in FIG. 2.

Referring to FIG. 15, a vehicle control apparatus 1500 provided in some embodiments of the disclosure may include a receiving unit 1502, a generation unit 1504, a presentation unit 1506, and an interaction unit 1508.

The receiving unit 1502 may be configured to receive vehicle status information transmitted by a vehicle and road environment information of the vehicle in a human remote driving mode. The generation unit 1504 may be configured to perform scene rendering processing according to the road environment information to obtain a road environment of the vehicle. The presentation unit 1506 may be configured to present the road environment of the vehicle. The interaction unit 1508 may be configured to receive a remote control instruction, the remote control instruction being triggered by a remote driver based on the road environment and the vehicle status information, and transmit the remote control instruction to the vehicle.

FIG. 16 is a schematic structural diagram of an electronic device for implementing a vehicle control method according to some embodiments of the disclosure.

A computer system 1600 of the electronic device shown in FIG. 16 is merely an example and is not to constitute any limitation on functions and use scopes of the embodiments of the disclosure.

As shown in FIG. 16, the computer system 1600 may include a central processing unit (CPU) 1601, which may perform various suitable actions and processing based on a program stored in a read-only memory (ROM) 1602 or a program loaded from a storage part 1608 into a random access memory (RAM) 1603, for example, perform the method described in the foregoing embodiments. The RAM 1603 may further store various programs and data required for system operations. The CPU 1601, the ROM 1602, and the RAM 1603 may be connected to each other through a bus 1604. An input/output (I/O) interface 1605 may also be connected to the bus 1604.

The following components may be connected to the I/O interface 1605: an input part 1606 including a keyboard and a mouse; an output part 1607 including a cathode ray tube (CRT), a liquid crystal display (liquid crystal), and a speaker; a storage part 1608 including a hard disk; and a communication part 1609 including a network interface card such as a local area network (LAN) card and a modem. The communication part 1609 may perform communication processing by using a network such as the Internet. A driver 1610 may also be connected to the I/O interface 1605 as required. A removable medium 1611, such as a magnetic disk, an optical disk, a magneto-optical disk, or a semiconductor memory, may be mounted on the driver 1610 as required, so that a computer program read therefrom may be installed into the storage part 1608 as required.

According to some embodiments of the disclosure, the processes described in the following with reference to the flowcharts may be implemented as computer software programs. For example, some embodiments of the disclosure may include a computer program product. The computer program product may include a computer program stored in a computer-readable medium. The computer program may include a computer program used for performing a method shown in the flowchart. In such embodiments, the computer program may be downloaded and installed from a network through the communication part 1609, and/or installed from the removable medium 1611. When the computer program is executed by the CPU 1601, the various functions defined in the system of the disclosure may be performed.

The computer-readable medium shown in the embodiments of the disclosure may be a computer-readable signal medium or a computer-readable storage medium or any combination thereof. The computer-readable storage medium may be, for example, but is not limited to, an electric, magnetic, optical, electromagnetic, infrared, or semi-conductive system, apparatus, or component, or any combination of the above. More specific examples of the computer-readable storage medium may include, but are not limited to: an electrical connection having one or more wires, a portable computer disk, a hard drive, a RAM, a ROM, an erasable programmable read-only memory (EPROM), a flash memory, an optical fiber, a compact disc read-only memory (CD-ROM), an optical storage device, a magnetic storage device, or any suitable combination of the above. In the disclosure, the computer-readable storage medium may be any tangible medium containing or storing a program, and the program may be used by or used in combination with an instruction execution system, an apparatus, or a device. In the disclosure, the computer-readable signal medium may include a data signal transmitted in a baseband or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The computer program contained on the computer-readable medium may be transmitted using any suitable medium, including but not limited to: wireless, wired, or any suitable combination thereof.

The flowcharts and block diagrams in the accompanying drawings illustrate possible system architectures, functions and operations that may be implemented by a system, a method, and a computer program product according to various embodiments of the disclosure. Each box in a flowchart or a block diagram may represent a module, a program segment, or a part of code. The module, the program segment, or the part of code includes one or more executable instructions used for implementing specified logic functions. In some alternative implementations, the functions marked in the blocks may alternatively occur in a different order from that marked in the accompanying drawings. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

A related unit described in the embodiments of the disclosure may be implemented in a software manner, or may be implemented in a hardware manner, and the unit described can also be set in a processor. Names of the units do not constitute a limitation on the units in a specific case.

Some embodiments of the disclosure may further provide a computer-readable medium. The computer-readable medium may be included in the electronic device described in the foregoing embodiment; or may exist alone, without being assembled into the electronic device. The computer-readable medium may carry one or more programs, the one or more programs, when executed by the electronic device, causing the electronic device to implement the method described in the foregoing embodiments.

Although a plurality of modules or units of a device configured to perform actions are discussed in the foregoing detailed description, such division is not mandatory. Actually, according to the implementations of the disclosure, the features and functions of two or more modules or units described above may be specifically implemented in one module or unit. On the other hand, the features and functions of one module or unit described above may be further divided to be embodied by a plurality of modules or units.

According to the foregoing descriptions of the implementations, a person skilled in the art may readily understand that the exemplary implementations described herein may be implemented by using software, or may be implemented by combining software and necessary hardware. Therefore, the technical solutions of the embodiments of the disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of the disclosure.

It is to be understood that the disclosure is not limited to the precise structures described above and shown in the accompanying drawings, and various modifications and changes can be made without departing from the scope of the disclosure. The scope of the disclosure is subject only to the appended claims.

What is claimed is:

1. A vehicle control method performed by at least one processor, the method comprising:
receiving vehicle information from a vehicle;
receiving roadside information from a roadside device, wherein the vehicle is within a coverage area of the roadside device; and
establishing a configuration for performing remote driving for the vehicle based on the vehicle information and the roadside information.

2. The vehicle control method according to claim 1, further comprising establishing a communication connection to the roadside device through a wired connection.

3. The vehicle control method according to claim 1, wherein:
the roadside information comprises a sensing coverage area of the roadside device and sensing capability information of the roadside device;
the vehicle information comprises vehicle status information and location information of the vehicle;
the establishing the configuration for performing the remote driving comprises:
in a case that it is determined according to the location information that the vehicle is located within the sensing coverage area of the roadside device, generating, according to the sensing capability information of the roadside device, uplink configuration information for remotely controlling the vehicle, the uplink configuration information being used for indicating data that needs to be transmitted by the vehicle; and
transmitting the uplink configuration information to the vehicle.

4. The vehicle control method according to claim 3, wherein the generating comprises:
in a case that it is determined according to the sensing capability information of the roadside device that the roadside device is capable of providing road environment information of the vehicle, generating uplink configuration information for indicating reduction of data transmission of the vehicle.

5. The vehicle control method according to claim 3 further comprising:
obtaining road environment information of the vehicle sensed by the roadside device, and receiving vehicle status data transmitted by the vehicle;
generating a remote control instruction based on the vehicle status data and the road environment information; and
transmitting the remote control instruction to the vehicle, the remote control instruction being used for remotely controlling the vehicle to travel.

6. The vehicle control method according to claim 1, further comprising establishing a communication connection to the roadside device through a wired connection, wherein the vehicle information is received from the vehicle via the roadside device, and wherein the configuration for performing the remote driving is established via the roadside device.

7. The vehicle control method according to claim 1, wherein:
the vehicle information comprises vehicle status information of the vehicle, the roadside information comprises road environment information of the vehicle, and the vehicle status information of the vehicle is transmitted by the vehicle to the roadside device; and
the establishing the configuration for performing the remote driving comprises:
generating a remote control instruction according to the vehicle status information and the road environment information; and
transmitting the remote control instruction to the roadside device, the remote control instruction being used for transmitting a control instruction to the vehicle by the roadside device based on the remote control instruction.

8. The vehicle control method according to claim 7, wherein the roadside information further comprises sensing coverage area and communication capability information of the roadside device; further comprising, in a case that it is determined according to the sensing coverage area and the communication capability information of the roadside device that the roadside device is capable of assisting in remote driving, switching communication with the vehicle to communication between the vehicle and the roadside device.

9. The vehicle control method according to claim 1, wherein:
the vehicle information comprises vehicle status information of the vehicle, the roadside information comprises road environment information of the vehicle, the vehicle status information and the road environment information are received in a human remote driving mode; and
the establishing the configuration for performing the remote driving comprises:
performing scene rendering according to the road environment information to obtain a road environment of the vehicle;
presenting the road environment of the vehicle;
receiving a remote control instruction, the remote control instruction being triggered by a remote driver based on the road environment and the vehicle status information; and
transmitting the remote control instruction to the vehicle.

10. The vehicle control method according to claim 1, wherein the road environment information of the vehicle is received through structured data.

11. A vehicle control apparatus comprising:
at least one memory containing program code; and
at least one processor configured to execute the program code, the program code comprising:
first receiving code configured to cause the at least one processor to receive vehicle information from a vehicle;
second receiving code configured to cause the at least one processor to receive roadside information from a roadside device, wherein the vehicle is within a coverage area of the roadside device; and
first establishing code configured to cause the at least one processor to establish a configuration for performing a remote driving for the vehicle based on the vehicle information and the roadside information.

12. The vehicle control apparatus according to claim 11, the program code further comprising second establishing code configured to cause the at least one processor to establish a communication connection to the roadside device through a wired connection.

13. The vehicle control apparatus according to claim 11, wherein:
the roadside information comprises a sensing coverage area of the roadside device and sensing capability information of the roadside device;
the vehicle information comprises vehicle status information and location information of the vehicle;
the computer program code further includes:
first generating code configured to cause the at least one processor to, in a case that it is determined according to the location information that the vehicle is located within the sensing coverage area of the roadside device, generate, according to the sensing capability information of the roadside device, uplink configuration information for remotely controlling the vehicle, the uplink configuration information being used for indicating data that needs to be transmitted by the vehicle; and
first transmitting code configured to cause the at least one processor to transmit the uplink configuration information to the vehicle.

14. The vehicle control apparatus according to claim 13, wherein the first generating code comprises:
second generating code configured to cause the at least one processor to generate uplink configuration information for indicating reduction of data transmission of the vehicle in a case that it is determined according to the sensing capability information of the roadside device that the roadside device is capable of providing road environment information of the vehicle.

15. The vehicle control apparatus according to claim 13, wherein, the program code further comprises:
first obtaining code configured to cause the at least one processor to obtain road environment information of the vehicle sensed by the roadside device after the uplink configuration information is transmitted to the vehicle,
third receiving code configured to cause the at least one processor to receive vehicle status data transmitted by the vehicle;
third generating code configured to cause the at least one processor to generate a remote control instruction based on the vehicle status data and the road environment information; and
second transmitting code configured to cause the at least one processor to transmit the remote control instruction to the vehicle, the remote control instruction being used for remotely controlling the vehicle to travel.

16. The vehicle control apparatus according to claim 11, the program code further comprising second establishing code configured to cause the at least one processor to establish a communication connection to the roadside device through a wired connection, wherein the vehicle information is received from the vehicle via the roadside device, and wherein the configuration for performing the remote driving may be established via the roadside device.

17. The vehicle control apparatus according to claim 11, wherein:
the vehicle information comprises vehicle status information of the vehicle, the roadside information comprises road environment information of the vehicle, and the vehicle status information of the vehicle is transmitted by the vehicle to the roadside device; and
the first establishing code comprises:
first generating code configured to cause the at least one processor to generate a remote control instruction according to the vehicle status information and the road environment information; and
first transmitting code configured to cause the at least one processor to transmit the remote control instruction to the roadside device, the remote control instruction being used for transmitting a control instruction to the vehicle by the roadside device based on the remote control instruction.

18. The vehicle control apparatus according to claim 17, wherein the roadside information further comprises sensing coverage area and communication capability information of the roadside device; and wherein the program code further comprises first switching code configured to cause the at least one processor to switch communication with the vehicle to communication between the vehicle and the roadside device in a case that it is determined according to the sensing coverage area and the communication capability information of the roadside device that the roadside device is capable of assisting in remote driving.

19. The vehicle control apparatus according to claim 11, wherein:
the vehicle information comprises vehicle status information of the vehicle, the roadside information comprises road environment information of the vehicle, the vehicle status information and the road environment information are received in a human remote driving mode; and
the first establishing code comprises:
first performing code configured to cause the at least one processor to perform scene rendering according to the road environment information to obtain a road environment of the vehicle;
first presenting code configured to cause the at least one processor to present the road environment of the vehicle;
third receiving code configured to cause the at least one processor to receive a remote control instruction, the remote control instruction being triggered by a remote driver based on the road environment and the vehicle status information; and
first transmitting code configured to cause the at least one processor to transmit the remote control instruction to the vehicle.

20. A non-transitory computer-readable medium for vehicle control containing program code that when executed by at least one processor, causes the at least one processor to:
receive vehicle information from a vehicle;
receive roadside information from a roadside device, wherein the vehicle is within a coverage area of the roadside device; and
establish a configuration for performing a remote driving for the vehicle based on the vehicle information and the roadside information.
